(19) United States
(12) Patent Application Publication
(10) Pub. No.: US 2026/0137494 A1
(43) Pub. Date: May 21, 2026

(54) REPLACEABLE FLOSS DEVICE

(71) Applicant: LG H&H CO., LTD., Seoul (KR)

(72) Inventors: Jonghoon LEE, Seoul (KR); Kyungsub LEE, Seoul (KR); Sungho CHA, Seoul (KR)

(73) Assignee: LG H&H CO., LTD., Seoul (KR)

(21) Appl. No.: 19/394,624

(22) Filed: Nov. 19, 2025

(30) Foreign Application Priority Data
Nov. 20, 2024 (KR) 10-2024-0166670

(51) Int. Cl. A61C 15/04

(52) U.S. Cl. CPC A61C 15/048

(57) ABSTRACT

According to an embodiment of the present disclosure, a replaceable floss device is provided. The replaceable floss device may include a main body extending in a longitudinal direction and including a handle portion and a head unit, the head unit being configured to form a receiving area spaced apart from the handle portion in the longitudinal direction and including a receiving protrusion and a receiving recess; and a replaceable floss unit replaceably coupled to the main body, and including a base portion including a coupling protrusion and a coupling recess, an arm portion extending in a direction different from the direction in which the base portion extends, and a floss coupled to the arm portion.

### CROSS-REFERENCE TO RELATED APPLICATION

The application claims priority to and the benefit of Korean Patent Application No. 10-2024-0166670, filed November 20, 2024, which is hereby incorporated by reference for all purposes as if fully set forth herein.

### BACKGROUND

### FIELD

The present disclosure relates to a replaceable floss device.

### DISCUSSION

Floss is a tool used to remove food debris and plaque remaining around teeth, periodontal tissues, and gums in order to maintain oral hygiene. Floss can help maintain the cleanliness of interdental areas that are difficult to reach with a toothbrush, thereby contributing to the promotion of periodontal and dental health.

Disposable floss, discarded after a single use, can negatively impact the environment. Furthermore, to effectively clean around teeth and gums, floss must maintain consistent tension during use.

### SUMMARY

One aspect of the present disclosure is to provide a replaceable floss device configured to maintain tension in the floss during use, thereby enabling effective oral hygiene management.

One aspect of the present disclosure is to provide a replaceable floss device configured to allow the floss to be replaced, thereby enhancing its eco-friendly characteristics.

One aspect of the present disclosure is to provide a replaceable floss device configured to allow a user to easily replace and couple the floss.

According to an embodiment of the present disclosure, the replaceable floss device may include a main body extending in a longitudinal direction and including a handle portion and a head unit, the head unit being configured to form a receiving area spaced apart from the handle portion in the longitudinal direction and including a receiving protrusion and a receiving recess; and a replaceable floss unit replaceably coupled to the main body, and including a base portion including a coupling protrusion and a coupling recess, an arm portion extending in a direction different from the direction in which the base portion extends, and a floss coupled to the arm portion. When the replaceable floss unit is coupled to the main body, the base portion is positioned in the receiving area so that the coupling protrusion and the receiving recess may be in contact with each other and the coupling recess and the receiving protrusion may be in contact with each other. The replaceable floss unit may be coupled to the head unit along a coupling direction in which the floss and the base portion are spaced apart from each other, and the coupling direction and the longitudinal direction may be different from each other. The receiving area may include a first receiving end open toward the handle portion and a second receiving end formed opposite the first receiving end, and overlap at least a portion of the handle portion along the longitudinal direction.

According to an embodiment, the replaceable floss device may further include an open area fluidically connected to the receiving area and surrounded by at least a portion of the handle portion and at least a portion of the head unit. The handle portion may further include a curved neck portion forming at least a portion of the open area, connected to at least a portion of the head unit, and having an outer surface that is curved on a side facing the open area.

According to an embodiment, the head unit may include a connecting head unit, a coupling head unit, and a spacer head unit formed integrally with each other to form a U-shape. The connecting head unit may be connected to one end of the coupling head unit and the spacer head unit may be connected to the other end of the coupling head unit. The curved neck portion may be connected to the connecting head unit and may be physically spaced apart from the spacer head unit.

According to an embodiment, the base portion may include a front surface facing the floss and a rear surface formed opposite the front surface. When the replaceable floss unit is coupled to the main body, the front surface of the base portion may be in contact with the coupling head unit and the rear surface of the base portion may be open so that the coupling head unit may press at least a portion of the base portion.

According to an embodiment, the arm portion may include a first arm portion extending from one end of the base portion and a second arm portion extending from the other end of the base portion. The floss may be coupled between the first arm portion and the second arm portion. When the replaceable floss unit is coupled to the main body, the first arm portion may be provided in the open area and the second arm portion may be provided around the second receiving end.

According to an embodiment, the open area formed by the curved neck portion may be not formed on the second receiving end.

According to an embodiment, the floss may have a first tension when the replaceable floss unit is not coupled to the main body and have a second tension greater than the first tension when the replaceable floss unit is coupled to the main body. A straight-line distance between distal ends of the first arm portion and the second arm portion may be a first distance when the replaceable floss unit is not coupled to the main body and may be a second distance greater than the first distance when the replaceable floss unit is coupled to the main body.

According to an embodiment, a curvature of the base portion may be a first curvature when the replaceable floss unit is not coupled to the main body and may be a second curvature smaller than the first curvature when the replaceable floss unit is coupled to the main body.

According to an embodiment, the replaceable floss unit may further include a coupling portion being in contact with at least a portion of the head unit when the replaceable floss unit and the head unit are coupled to each other, and having a cavity structure. A direction in which the coupling portion and the floss are spaced apart from each other may be different from the longitudinal direction. At least a portion of the coupling portion may be formed by the base portion, and another portion of the coupling portion may be formed by the arm portion. The coupling portion may include a first coupling portion adjacent to the first arm portion and a second coupling portion adjacent to the second arm portion.

According to an embodiment, the coupling portion may form a first included angle when the replaceable floss unit is not coupled to the main body, and the coupling portion may form a second included angle when the replaceable floss unit is coupled to the main body. The second included angle may be greater than the first included angle.

According to an embodiment, the first included angle may be 90 degrees or less.

According to an embodiment, the coupling portion may include an inner surface and include a fastening portion which is an end of the inner surface adjacent to an inner portion of the arm portion. When the replaceable floss unit is not coupled to the main body, the fastening portion of the first coupling portion and the fastening portion of the second coupling portion may be spaced apart from each other by a first separation distance, and when the replaceable floss unit is coupled to the main body, the fastening portion of the first coupling portion and the fastening portion of the second coupling portion may be spaced apart from each other by a second separation distance. The first separation distance may be smaller than the second separation distance and smaller than a head length of the coupling head unit.

According to an embodiment, each of the receiving protrusion and the coupling protrusion may have a curved cross-sectional shape. Each of the receiving recess and the coupling recess may have a cross-sectional shape corresponding to the receiving protrusion and the coupling protrusion.

According to an embodiment, the base portion may have a thickness greater than that of the arm portion.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 is a schematic front perspective view illustrating the main body and the replaceable floss unit forming the replaceable floss device according to an embodiment.

FIG. 2 is a schematic rear perspective view illustrating the replaceable floss device according to an embodiment.

FIG. 3 is a schematic side view illustrating the replaceable floss device according to the embodiment.

FIG. 4 is a schematic side view illustrating the main body and the replaceable floss unit according to the embodiment.

FIG. 5 is another schematic side view illustrating the main body according to the embodiment.

FIG. 6 is a schematic perspective view illustrating the replaceable floss unit according to the embodiment.

FIG. 7 is a schematic diagram illustrating a structure in which replaceable floss units according to an embodiment are prepared by being coupled to each other.

FIG. 8 is a schematic diagram illustrating a structure before the replaceable floss unit according to the embodiment is coupled to the head unit.

FIG. 9 is a schematic diagram illustrating a structure after the replaceable floss unit according to the embodiment is coupled to the head unit.

### DETAILED DESCRIPTION OF THE ILLUSTRATED EMBODIMENTS

As the present disclosure allows for various changes and numerous embodiments, particular embodiments will be illustrated in the drawings and described in detail in the written description. However, this is not intended to limit the present disclosure to particular modes of practice, and it is to be appreciated that all changes, equivalents, and substitutes that do not depart from the spirit and technical scope of the present disclosure are encompassed in the present disclosure.

It will be understood that, although the terms "first", "second", etc. may be used herein to describe various elements, these elements should not be limited by these terms. These terms are only used to distinguish one element from another element. For instance, a first element discussed below could be termed a second element without departing from the scope of the present disclosure. Similarly, the second element could also be termed the first element. In the description below, the singular expressions are intended to include the plural expressions as well, unless the context clearly indicates otherwise.

It will be further understood that the terms "comprise", "include", "have", etc. used in the disclosure, specify the presence of stated features, integers, steps, operations, elements, components, and/or combinations of them but do not preclude the presence or addition of one or more other features, integers, steps, operations, elements, components, and/or combinations thereof. In addition, when a first part such as a layer, film, region, plate, etc. is on a second part, the first part may be not only "directly on" the second part but a third part may intervene between them. Furthermore, in the disclosure, when a first part such as a layer, film, region, plate, etc. is formed on a second part, a direction in which the first part is formed is not limited to an upper direction of the second part, but may include a side or a lower direction of the second part. To the contrary, when a first part such as a layer, film, region, plate, etc. is "under" a second part, the first part may be not only "directly under" the second part but a third part may intervene between them.

The present disclosure relates to a replaceable floss device. The replaceable floss device according to an embodiment will now be described with reference to the accompanying drawings.

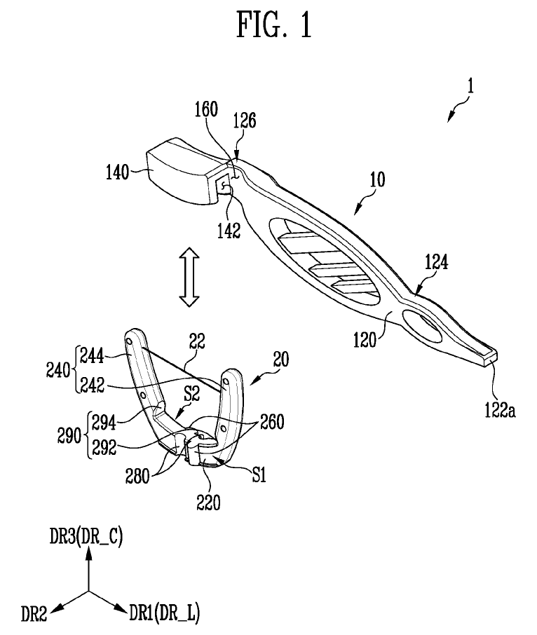

With reference to FIGS. 1 through 7, a replaceable floss device 1 according to an embodiment is described.

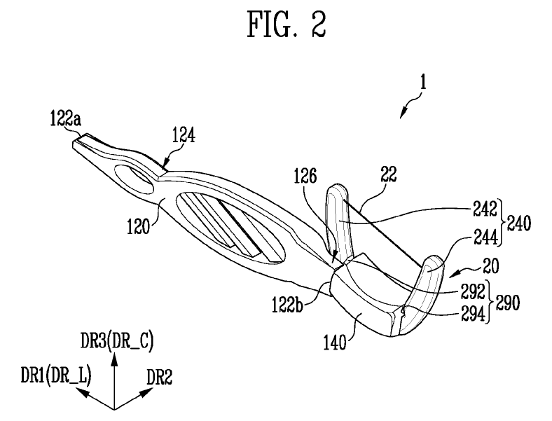

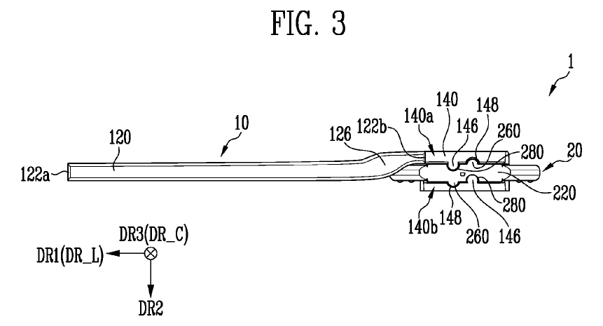

FIG. 1 is a schematic front perspective view illustrating the main body and the replaceable floss unit forming the replaceable floss device according to an embodiment. FIG. 2 is a schematic rear perspective view illustrating the replaceable floss device according to an embodiment. FIG. 3 is a schematic side view illustrating the replaceable floss device according to an embodiment. FIG. 1 schematically illustrates a structure before the main body 10 and the replaceable floss unit 20 are coupled. FIGS. 2 and 3 illustrate the replaceable floss device 1 according to an embodiment, and illustrate the structure in which the main body 10 and the replaceable floss unit 20 are coupled to each other.

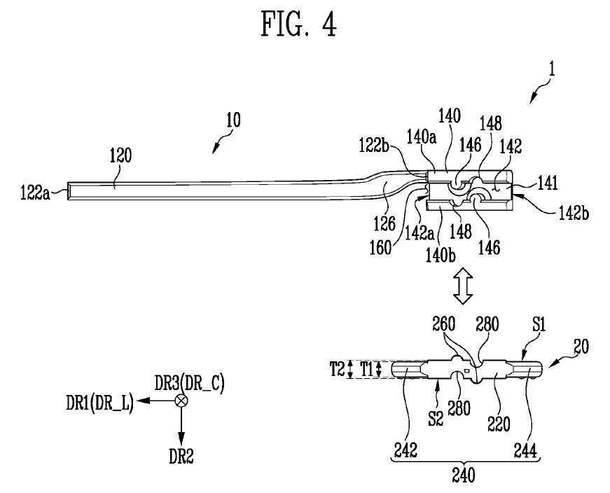

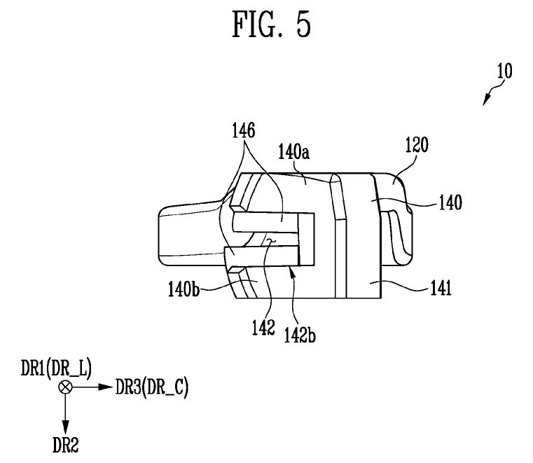

FIG. 4 is a schematic side view illustrating the main body and the replaceable floss unit according to an embodiment. FIG. 4 schematically illustrates the main body 10 viewed from the same direction as in FIG. 3. FIG. 5 is another schematic side view illustrating the main body according to the embodiment. FIG. 5 schematically illustrates the main body 10 according to the embodiment as viewed from the head edge direction.

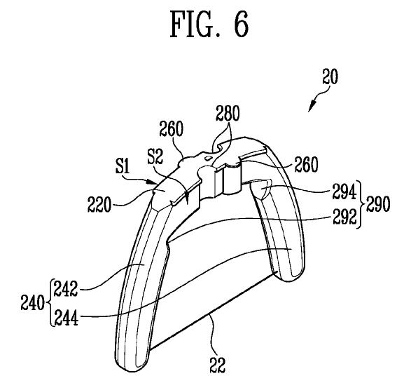

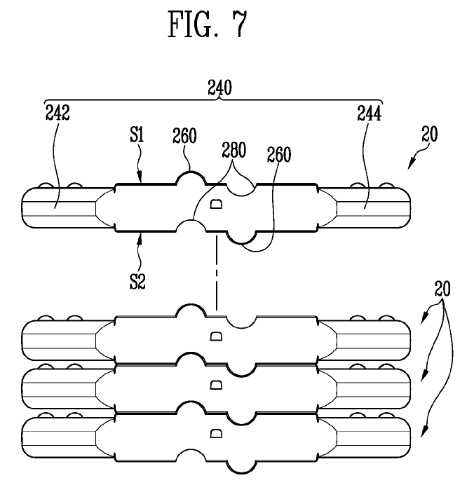

FIG. 6 is a schematic perspective view illustrating the replaceable floss unit according to the embodiment. FIG. 7 is a schematic diagram illustrating a structure where replaceable floss units according to an embodiment are prepared by being coupled to each other.

The replaceable floss device 1 may be a tool for removing food debris and plaque remaining around teeth, periodontal tissues, and gums in order to maintain the user's oral hygiene.

The replaceable floss device 1 may include the main body 10 and may include the replaceable floss unit 20 that can be replaceably coupled to the main body 10.

After the replaceable floss unit 20 is coupled to the main body 10, a user may grasp a portion of the main body 10 to floss. The replaceable floss unit 20 may be decoupled from the main body 10, and a new replaceable floss unit 20 may be recoupled to the main body 10.

In this case, at least a part of the replaceable floss device 1 may be reusable, thereby reducing the risk of environmental pollution caused by unnecessary waste such as discarded plastic.

In this specification, a first direction DR1, a second direction DR2, and a third direction DR3 may be defined. The first direction DR1 may be a longitudinal direction DR_L in which the main body 10 (or handle portion 120) extends. The second direction DR2 may be a thickness direction of a head unit 140. The third direction DR3 may be a direction in which an arm portion 240 extends when the main body 10 and the replaceable floss unit 20 are coupled to each other. The third direction DR3 may be a thickness direction of a coupling head unit 141. The third direction DR3 may be a direction in which a base portion 220 and a floss 22 are separated.

According to an embodiment, the third direction DR3 may be referred to as a coupling direction DR_C. The coupling direction DR_C may differ from the longitudinal direction DR_L. For example, the coupling direction DR_C may be perpendicular to the longitudinal direction DR_L. However, the present disclosure is not limited thereto.

The main body 10 may extend in the longitudinal direction DR_L. According to an embodiment, the main body 10 may include the handle portion 120 and the head unit 140 spaced apart from each other in the longitudinal direction DR_L. According to an embodiment, the main body 10 may further include an open area 160.

The handle portion 120 may include a portion gripped by the user during flossing. For example, the handle portion 120 may extend in the longitudinal direction DR_L in an area spaced apart from the head unit 140 along the longitudinal direction DR_L.

The handle portion 120 may include a first handle end 122a and a second handle end 122b. The first handle end 122a may be a tail portion spaced apart from the head unit 140. The second handle end 122b may be a head portion coupled to the head unit 140.

According to an embodiment, at least a portion of the handle portion 120 may include a concave portion 124 for convenient user grip and may have a width that generally tapers toward the first handle end 122a.

The handle portion 120 may be made of a material such as plastic. However, the present disclosure is not limited thereto.

The handle portion 120 may further include various hole structures. Accordingly, the aesthetic appearance of the replaceable floss device 1 may be enhanced, and the user's grip comfort and overall usability may be improved.

The handle portion 120 may include a curved neck portion 126 that forms at least a portion of the open area 160. The open area 160 may be surrounded by at least a portion of the handle portion 120.

The curved neck portion 126 may be a portion formed on at least a portion of the handle portion 120. The curved neck portion 126 may be formed adjacent to the second handle end 122b. A portion of the curved neck portion 126 may be coupled to the head unit 140.

The curved neck portion 126 may face the head unit 140. The curved neck portion 126 may be directly adjacent to the open area 160. The curved neck portion 126 may have an outer surface that is curved on the side facing the open area 160. For example, the curved neck portion 126 may have an outer surface extending along an inclined direction with respect to the first direction DR1 and the second direction DR2.

The curved neck portion 126 may be connected (or coupled) to at least a portion of the head unit 140. The curved neck portion 126 may be connected (or coupled) to a connecting head unit 140a and may not be connected (or coupled) to a spacer head unit 140b. The curved neck portion 126 may be physically spaced apart from the spacer head unit 140b. That is, the curved neck portion 126, by being connected to a portion of the head unit 140, spaced apart from another portion, and having the outer surface extending along an inclined direction, may form the open area 160.

The head unit 140 may include a portion to which the replaceable floss unit 20 is coupled. For example, the head unit 140 may include (e.g., form) a receiving area 142 (see FIG. 4) where at least a portion of the replaceable floss unit 20 is provided.

The head unit 140 may be connected to the second handle end 122b of the handle portion 120. According to an embodiment, the head unit 140 and the handle portion 120 may be integral. Alternatively, according to another embodiment, the head unit 140 and the handle portion 120 may be manufactured separately and then provided in a combined state. However, it is understood that the present disclosure is not limited to specific examples.

The head unit 140 may be made of materials such as plastic. However, the present disclosure is not limited thereto.

The head unit 140 may include the coupling head unit 141, the connecting head unit 140a, and the spacer head unit 140b.

The coupling head unit 141, the connecting head unit 140a, and the spacer head unit 140b may be formed integrally and may have a U-shaped that is generally open in the direction in which the replaceable floss unit 20 is coupled. Accordingly, the coupling head unit 141, the connecting head unit 140a, and the spacer head unit 140b may form the receiving area 142.

For example, each of the coupling head unit 141, the connecting head unit 140a, and the spacer head unit 140b may have a predetermined width in the third direction DR3 and may extend in the first direction DR1. Furthermore, each of the connecting head unit 140a and the spacer head unit 140b may be connected to both ends of the coupling head unit 141 and may be spaced apart from each other in the second direction DR2.

The connecting head unit 140a may be connected to the handle portion 120 (e.g., the curved neck portion 126). The spacer head unit 140b may be spaced apart from the handle portion 120 (e.g., the curved neck portion 126).

The coupling head unit 141, the connecting head unit 140a, and the spacer head unit 140b may be adjacent (e.g., directly adjacent) to the open area 160.

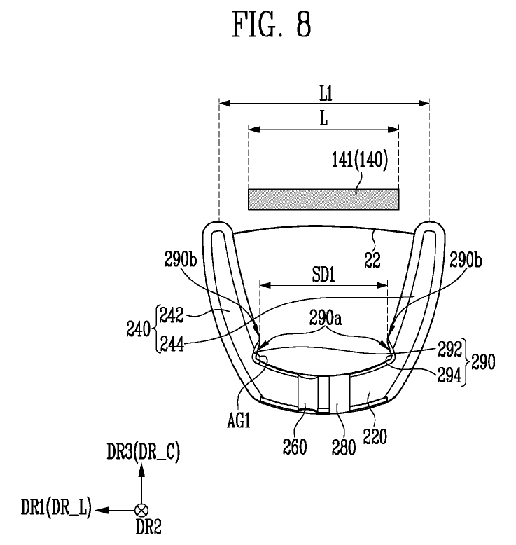

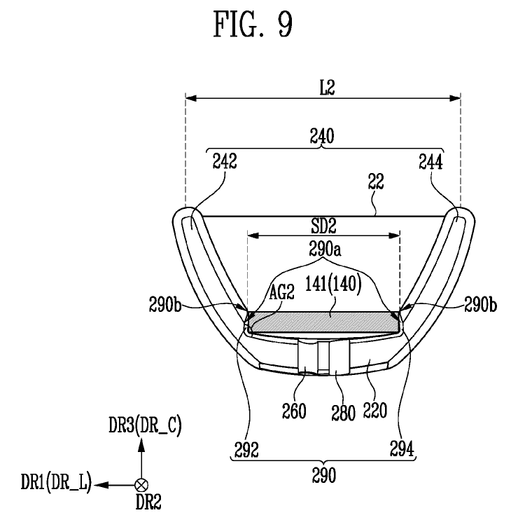

The coupling head unit 141 may be a portion that presses at least a portion of the base portion 220 and a coupling portion 290 when the replaceable floss unit 20 is coupled to the main body 10. Detailed descriptions related thereto will be described later with reference to FIGS. 8 and 9.

According to an embodiment, the head unit 140 may include (e.g., form) the receiving area 142. The receiving area 142 of the head unit 140 may include a first receiving end 142a and a second receiving end 142b.

The first receiving end 142a may be one end of the receiving area 142 facing the handle portion 120. The second receiving end 142b may be the other end of the receiving area 142 not facing the handle portion 120. The first receiving end 142a may be open toward the handle portion 120. The second receiving end 142b may be formed opposite the first receiving end 142a.

The receiving area 142 may be fluidically connected to the open area 160 at the first receiving end 142a. The receiving area 142 may be directly adjacent to the open area 160 at the first receiving end 142a. The receiving area 142 may overlap at least a portion of the handle portion 120 along the longitudinal direction DR_L. That is, according to an embodiment, the receiving area 142 may overlap the open area 160 along the longitudinal direction DR_L.

According to an embodiment, the head unit 140 may include a receiving protrusion 146 and a receiving recess 148.

The receiving protrusion 146 may be formed on each of the connecting head unit 140a and the spacer head unit 140b so as to face the receiving area 142. The receiving protrusion 146 may include a plurality of receiving protrusions 146. Some of the plurality of receiving protrusions 146 may be formed on the connecting head unit 140a, and other parts of the plurality of receiving protrusions 146 may be formed on the spacer head unit 140b.

The receiving protrusion 146 may extend in the third direction DR3 and may protrude in a direction parallel to the second direction DR2.

According to an embodiment, the receiving protrusion 146 may have a curved cross-sectional shape. However, the present disclosure is not limited thereto. According to an embodiment, the receiving protrusion 146 may have a semi-cylindrical shape. However, the present disclosure is not limited thereto.

The receiving recess 148 may be recessed into each of the connecting head unit 140a and the spacer head unit 140b so as to be away from the receiving area 142. The receiving recess 148 may include a plurality of receiving recesses 148. Some of the plurality of receiving recesses 148 may be formed on the connecting head unit 140a, and other parts of the plurality of receiving recesses 148 may be formed on the spacer head unit 140b.

The receiving recess 148 may extend in the third direction DR3 and may be recessed in a direction parallel to the second direction DR2.

According to an embodiment, the receiving recess 148 may have a shape corresponding to a coupling protrusion 260. For example, the receiving recess 148 may have a curved cross-sectional shape. However, the present disclosure is not limited thereto. According to an embodiment, the receiving recess 148 may have a semi-cylindrical shape. However, the present disclosure is not limited thereto.

The receiving protrusion 146 and the receiving recess 148 may be alternately arranged along the first direction DR1 in the connecting head unit 140a. The receiving protrusion 146 and the receiving recess 148 may be alternately arranged along the first direction DR1 in the spacer head unit 140b.

The receiving protrusion 146 and receiving recess 148 may overlap along the second direction DR2. For example, the receiving protrusion 146 on the connecting head unit 140a and the receiving recess 148 on the spacer head unit 140b may overlap each other along the second direction DR2 and may form a pair with each other. The receiving protrusion 146 on the spacer head unit 140b and the receiving recess 148 on the connecting head unit 140a may overlap each other along the second direction DR2 and may form a pair with each other.

Accordingly, in the head unit 140, the receiving protrusion 146 and the receiving recess 148 may be adjacent to each other in the first direction DR1 and may be adjacent to each other in the second direction DR2.

The receiving area 142 may be an area where at least a portion of the replaceable floss unit 20 is coupled. For example, when the main body 10 and the replaceable floss unit 20 are coupled to each other, the base portion 220 may be provided in the receiving area 142.

The open area 160 may be surrounded by the handle portion 120 and the head unit 140. The open area 160 may be an area connected to the receiving area 142. The open area 160 may be an area formed by the curved neck portion 126.

The open area 160 may be an area where the arm portion 240 of the replaceable floss unit 20 is provided when the replaceable floss unit 20 and the main body 10 are coupled to each other. According to an embodiment, as the open area 160 is formed, areas where the replaceable floss unit 20 is provided may be asymmetrically formed around the first receiving end 142a and the second receiving end 142b, respectively.

According to an embodiment, since the areas where the replaceable floss unit 20 is provided are formed asymmetrically and thus visually distinguishable, the user may conveniently couple the replaceable floss unit 20 to the head unit 140. For example, the curved neck portion 126 forming the open area 160 may be configured such that visually distinct structures are observable in an area where the first receiving end 142a and the second receiving end 142b are adjacent. That is, according to the embodiment, the open area 160 formed by the curved neck portion 126 may not be formed at the second receiving end 142b.

When the replaceable floss unit 20 is coupled toward the head unit 140 in the third direction DR3, a first arm portion 242 may be provided in the open area 160, and a second arm portion 244 may be provided in the peripheral area of the second receiving end 142b of the receiving area 142 (e.g., the external area adjacent to the second receiving end 142b).

According to an embodiment, due to the open area 160 formed by the curved neck portion 126, the user may clearly recognize and align the coupling direction in which the replaceable floss unit 20 is coupled to the main body 10.

The replaceable floss unit 20 may generally have a U-shaped structure. The replaceable floss unit 20 may be provided as a cartridge structure. For example, the replaceable floss unit 20 may include a plurality of replaceable floss units 20 so that the replaceable floss device 1 is not used only once.

The replaceable floss unit 20 may be moved along the third direction DR3 and coupled to the head unit 140.

For example, the arm portion 240 and floss 22 of the replaceable floss unit 20 may be prepared to face the head unit 140, and the base portion 220 of the replaceable floss unit 20 may be moved along the third direction DR3 so that at least a portion of the head unit 140 and the base portion 220 may be coupled to each other.

The replaceable floss unit 20 may include the floss 22. The replaceable floss unit 20 may include the base portion 220, the arm portion 240, the coupling protrusion 260, a coupling recess 280, and the coupling portion 290.

When the user flosses, the floss 22 may be a part that comes into direct contact with a part of the user's oral cavity. The floss 22 may have a thread structure extending in one direction. One end of the floss 22 may be coupled to the first arm portion 242, and the other end of the floss 22 may be coupled to the second arm portion 244.

The floss 22 may include various materials, such as synthetic resin. For example, the floss 22 may include nylon or PTFE (polytetrafluoroethylene). However, the present disclosure is not limited thereto.

When the main body 10 and the replaceable floss unit 20 are coupled to each other, the floss 22 may be provided to extend along the longitudinal direction DR_L of the main body 10.

The tension (e.g., tensile force) of the floss 22 may differ before and after the replaceable floss unit 20 and the main body 10 are coupled to each other. For example, when the replaceable floss unit 20 is not coupled to the head unit 140, the floss 22 may have a first tension. When the replaceable floss unit 20 is coupled to the head unit 140, the floss 22 may have a second tension. The second tension may be greater than the first tension.

Accordingly, when using the replaceable floss device 1 according to the embodiment, the tension of the floss 22 in the replaceable floss unit 20 that is not coupled to the main body 10 may be maintained at a low level, thereby further extending its usable lifespan. Furthermore, when using the replaceable floss device 1, as the tension of the floss 22 is adequately maintained, the user may perform flossing in the oral cavity more efficiently, and oral cleanliness may be maintained more effectively. Detailed descriptions related thereto will be described later with reference to FIGS. 8 and 9.

The base portion 220 may form the base of the replaceable floss unit 20. The base portion 220 may generally extend parallel to the floss 22. For example, when the main body 10 and the replaceable floss unit 20 are coupled to each other, the base portion 220 may be provided to extend in the longitudinal direction DR_L of the main body 10.

According to an embodiment, the base portion 220 may include a front surface facing the floss 22 and a rear surface formed opposite the front surface. When the replaceable floss unit 20 is coupled to the main body 10, the front surface of the base portion 220 may be in contact with the coupling head unit 141, and the rear surface of the base portion 220 may be open (e.g., open to the outside).

The arm portion 240 may form an area where the floss 22 is coupled. For example, the arm portion 240 may include the first arm portion 242 and the second arm portion 244. The first arm portion 242 and the second arm portion 244 may be spaced apart and extend along the first direction DR1, and the floss 22 may be connected between the first arm portion 242 and the second arm portion 244.

The arm portion 240 may be integral with the base portion 220. For example, the first arm portion 242 may extend integrally along the third direction DR3 from one end of the base portion 220. The second arm portion 244 may extend integrally along the third direction DR3 from the other end of the base portion 220.

The base portion 220 and the arm portion 240 may be made of a material such as plastic. However, the present disclosure is not limited thereto.

The arm portion 240 may elastically extend in a direction parallel to the first direction DR1. Accordingly, when the arm portion 240 is elastically extended such that the first arm portion 242 and the second arm portion 244 are further spaced apart from each other, the tension of the floss 22 may be increased.

The arm portion 240 may extend generally in the third direction DR3 but may have a relatively curved shape. For example, each of the first arm portion 242 and the second arm portion 244 may have a shape curved inward toward the floss 22.

According to an embodiment, the base portion 220 may have a first thickness T1 relative to the second direction DR2. The arm portion 240 may have a second thickness T2 relative to the second direction DR2. The second thickness T2 may be greater than the first thickness T1. In this case, the replaceable floss unit 20 may be stably coupled to the head unit 140.

According to an embodiment, the base portion 220 may include the coupling protrusion 260 and the coupling recess 280.

The coupling protrusion 260 may be formed on the first surface S1 and the second surface S2 of the base portion 220, respectively. Here, the first surface S1 and the second surface S2 may be surfaces facing opposite directions in the second direction DR2.

The coupling protrusion 260 may extend in the third direction DR3 and may protrude in a direction parallel to the second direction DR2.

The coupling protrusion 260 may include a plurality of coupling protrusions 260. Some of the plurality of coupling protrusions 260 may be formed on the first surface S1 and protrude in a direction parallel to the second direction DR2. Other parts of the plurality of coupling protrusions 260 may be formed on the second surface S2 and protrude in a direction parallel to the second direction DR2.

According to an embodiment, the coupling protrusion 260 may have a curved cross-sectional shape. However, the present disclosure is not limited thereto. According to an embodiment, the coupling protrusion 260 may have a semi-cylindrical shape. However, the present disclosure is not limited thereto.

The coupling recess 280 may be formed on the first surface S1 and the second surface S2 of the base portion 220, respectively.

The coupling recess 280 may extend in the third direction DR3 and may be recessed in a direction parallel to the second direction DR2.

The coupling recess 280 may include a plurality of coupling recesses 280. Some of the plurality of coupling recesses 280 may be formed on the first surface S1 and may be recessed in a direction parallel to the second direction DR2. Other parts of the plurality of coupling recesses 280 may be formed on the second surface S2 and may be recessed in a direction parallel to the second direction DR2.

According to an embodiment, the coupling recess 280 may have a shape corresponding to the coupling protrusion 260. The coupling recess 280 may have a curved cross-sectional shape. However, the present disclosure is not limited thereto. According to an embodiment, the coupling recess 280 may have a semi-cylindrical shape. However, the present disclosure is not limited thereto.

The coupling protrusion 260 and the coupling recess 280 may be alternately arranged along the first direction DR1 on the first surface S1. The coupling protrusion 260 and the coupling recess 280 may be alternately arranged along the first direction DR1 on the second surface S2.

The coupling protrusion 260 and the coupling recess 280 may overlap along the second direction DR2. For example, the coupling protrusion 260 on the first surface S1 and the coupling recess 280 on the second surface S2 may overlap along the second direction DR2 and may form a pair with each other. The coupling protrusion 260 on the second surface S2 and the coupling recess 280 on the first surface S1 may overlap along the second direction DR2 and may form a pair with each other.

Accordingly, in the base portion 220, the coupling protrusion 260 and the coupling recess 280 may be adjacent to each other in the first direction DR1 and may be adjacent to each other in the second direction DR2.

According to an embodiment, when the replaceable floss unit 20 and the main body 10 are coupled to each other, the base portion 220 may be provided (e.g., placed) in the receiving area 142, and protrusions and recesses may be complementarily coupled to each other.

For example, when the replaceable floss unit 20 and the main body 10 are coupled to each other, the coupling protrusion 260 and the receiving recess 148 may be in contact with each other, and the coupling recess 280 and the receiving protrusion 146 may be in contact with each other. In this way, a structure in which protrusions and recesses contact each other may be formed at multiple locations. Accordingly, a portion where the replaceable floss unit 20 and the main body 10 are coupled to each other may be intuitively recognized, and the replaceable floss unit 20 and the main body 10 may be tightly coupled to each other. That is, the replaceable floss unit 20 and the main body 10 may be conveniently coupled to each other without requiring excessive separate fastening means.

When the head unit 140 and the replaceable floss unit 20 are coupled to each other, the coupling portion 290 may include a portion that directly contacts a portion of the head unit 140. The coupling portion 290 may have a recessed shape (e.g., a V-shaped recess).

For example, a portion of the coupling portion 290 may be formed by a portion of the base portion 220, and another portion of the coupling portion 290 may be formed by a portion of the arm portion 240. Since the portion of the base portion 220 and the portion of the arm portion 240 that form the coupling portion 290 extend in different directions, the coupling portion 290 may have a recessed structure with a generally V-shaped.

The coupling portion 290 may be formed around the area where the base portion 220 and the arm portion 240 are adjacent to each other. The coupling portion 290 may be formed at an end of the base portion 220 adjacent to the arm portion 240. The coupling portion 290 may be a cavity.

For example, the coupling portion 290 may include a first coupling portion 292 and a second coupling portion 294. The first coupling portion 292 may be a recess portion formed between one end of the base portion 220 and the first arm portion 242. The second coupling portion 294 may be a recess portion formed between the other end of the base portion 220 and the second arm portion 244.

According to an embodiment, a direction in which the coupling portion 290 and the floss 22 are separated may differ from the longitudinal direction DR_L. According to an embodiment, the direction in which the coupling portion 290 and the floss 22 are separated may be the same as a coupling direction DR_C.

According to an embodiment, a plurality of replaceable floss units 20 may be provided on the main body 10 so as to be replaceable.

Since the replaceable floss units 20 include the coupling protrusion 260 and the coupling recess 280 formed on each of the first and second surfaces S1 and S2, different replaceable floss units 20 may be coupled to each other and closely prepared in a narrow space.

For example, the coupling protrusion 260 and the coupling recess 280 formed on the first surface S1 of the replaceable floss unit 20 may be coupled to the coupling recess 280 and the coupling protrusion 260 formed on the second surface S2 of another replaceable floss unit 20.

With reference to FIGS. 8 and 9, a structure in which the tension of the floss 22 changes in the replaceable floss device 1 according to an embodiment will be described. For convenience of explanation, content that may overlap with the foregoing description will be briefly explained or omitted.

FIG. 8 is a schematic diagram illustrating a structure before the replaceable floss unit according to the embodiment is coupled to the head unit. FIG. 9 is a schematic diagram illustrating a structure after the replaceable floss unit according to the embodiment is coupled to the head unit. For convenience of explanation, FIGS. 8 and 9 primarily illustrate the coupling head unit 141, which is a portion of the head unit 140 to which the replaceable floss unit 20 is coupled.

Referring to FIGS. 8 and 9, before the replaceable floss unit 20 is coupled to the head unit 140, the floss 22 may have the relatively low first tension.

For example, when the replaceable floss unit 20 is not coupled to the head unit 140, the first and second arms 242 and 244 to which the floss 22 is coupled may be spaced apart from each other by a first distance L1. Here, the first distance L1 may be a straight-line distance between distal ends of the first and second arms 242 and 244.

Before the replaceable floss unit 20 is coupled to the head unit 140, the inner surface of the base portion 220 facing the floss 22 may have a first curvature.

Before the replaceable floss unit 20 is coupled to the head unit 140, the inner surface 290a of the coupling portion 290 may extend in a direction that faces relatively inward.

Before the replaceable floss unit 20 is coupled to the head unit 140, the coupling portion 290 may form a first included angle AG1. Before the replaceable floss unit 20 is coupled to the head unit 140, the first included angle AG1 may be formed by inner surfaces 290a of the first and second coupling portions 292 and 294 facing the area between the first and second arm portions 242 and 244 and the base portion 220. According to an embodiment, the first included angle AG1 may be 90 degrees or less.

Before the replaceable floss unit 20 is coupled to the head unit 140, the first coupling portion 292 and the second coupling portion 294 may be spaced apart from each other by a first separation distance SD1. For example, before the replaceable floss unit 20 is coupled to the head unit 140, a fastening portion 290b of the first coupling portion 292 and a fastening portion 290b of the second coupling portion 294 may be spaced apart from each other by the first separation distance SD1. Here, the fastening portion 290b may refer to the end of the inner surface 290a adjacent to the inner portion of the arm portion 240. Based on the fastening portion 290b, the extension direction of the inner surface 290a and the extension direction of the arm portion 240 may differ from each other. According to an embodiment, the first separation distance SD1 may be smaller than a head length L of the coupling head unit 141 in the first direction DR1.

After the replaceable floss unit 20 is coupled to the head unit 140, the floss 22 may have the second tension higher than the first tension.

For example, when the replaceable floss unit 20 is coupled to the head unit 140, the first and second arms 242 and 244 to which the floss 22 is coupled may be spaced apart from each other by a second distance L2 greater than the first distance L1. Here, the second distance L2 may be the straight-line distance between the distal ends of the first and second arms 242 and 244.

After the replaceable floss unit 20 is coupled to the head unit 140, the inner surface of the base portion 220 facing the floss 22 may have a second curvature smaller than the first curvature.

After the replaceable floss unit 20 is coupled to the head unit 140, the inner surface 290a of the coupling portion 290 may extend in a direction that faces relatively outward.

After the replaceable floss unit 20 is coupled to the head unit 140, the coupling portion 290 may form a second included angle AG2. After the replaceable floss unit 20 is coupled to the head unit 140, the second included angle AG2 may be formed by the inner surfaces 290a of the first and second coupling portions 292 and 294 facing the area between the first and second arm portions 242 and 244 and the base portion 220. The second included angle AG2 may be larger than the first included angle AG1.

After the replaceable floss unit 20 is coupled to the head unit 140, the first coupling portion 292 and the second coupling portion 294 may be spaced apart from each other by a second separation distance SD2. After the replaceable floss unit 20 is coupled to the head unit 140, the fastening portion 290b of the first coupling portion 292 and the fastening portion 290b of the second coupling portion 294 may be spaced apart from each other by the second separation distance SD2. According to an embodiment, the second separation distance SD2 may be the same as the head length L of the coupling head unit 141 in the first direction DR1. According to an embodiment, the second separation distance SD2 may be greater than the first separation distance SD1.

According to an embodiment, in order for the replaceable floss unit 20 to be coupled to the head unit 140, the replaceable floss unit 20 may be movable along the third direction DR3 so that the base portion 220 and the coupling portion 290 may be positioned adjacent to the coupling head unit 141.

The coupling protrusion 260 and coupling recess 280 may be complementarily coupled with the receiving recess 148 and receiving protrusion 146, and the base portion 220 and coupling portion 290 may be adjacent to the coupling head unit 141.

According to an embodiment, when the replaceable floss unit 20 is coupled to the head unit 140, the coupling head unit 141 may be fitted and coupled to one side of the base portion 220 and the coupling portion 290.

According to an embodiment, when the replaceable floss unit 20 is coupled to the head unit 140, the coupling head unit 141 may push both ends of the base portion 220 and the first and second coupling portions 292 and 294. For example, when the first and second coupling portions 292 and 294 are formed to be spaced apart from each other by the first separation distance SD1 smaller than the head length L, when the coupling head unit 141 enters, the coupling head unit 141 may push the inner surface 290a of each of the first and second coupling portions 292 and 294 to increase the first separation distance SD1. According to an embodiment, since the head length L is provided to be greater than the first separation distance SD1, the coupling head unit 141 may be configured to push at least a portion of the replaceable floss unit 20.

The coupling head unit 141 may push the first coupling portion 292 in a direction in which the first arm portion 242 is spaced apart from the second arm portion 244. The coupling head unit 141 may push the second coupling portion 294 in a direction in which the second arm portion 244 is spaced apart from the first arm portion 242. For example, the replaceable floss unit 20 may be deformed to form the second included angle AG2 larger than the first included angle AG1. For example, the replaceable floss unit 20 may be deformed to form the second separation distance SD2 greater than the first separation distance SD1.

Accordingly, the first and second arm portions 242 and 244 may be spaced apart from each other so as to be further separated in the first direction DR1, and the floss 22 coupled to the first and second arm portions 242 and 244 may be subjected to a pulling force in the first direction DR1. Accordingly, as the replaceable floss unit 20 is coupled to the head unit 140, the tension applied to the floss 22 may be increased.

According to an embodiment, the replaceable floss unit 20 and the main body 10 may be stably and replaceably coupled to each other, and when the replaceable floss unit 20 and the main body 10 are coupled, sufficient tension in the floss 22 may be ensured. Accordingly, the user may floss more efficiently using the replaceable floss device 1 according to the embodiment. Furthermore, when the replaceable floss unit 20 is not coupled to the main body 10, the floss 22 may be prepared to have relatively low tension. Consequently, the replaceable floss unit 20 may maintain a robust structure for a longer period, enabling stable use.

According to an embodiment of the present disclosure, a replaceable floss device configured to maintain tension in the floss during use may be provided, thereby enabling effective oral hygiene management.

According to an embodiment of the present disclosure, a replaceable floss device configured to allow the floss to be replaced may be provided, thereby enhancing eco-friendly characteristics.

According to an embodiment of the present disclosure, a replaceable floss device configured to allow a user to easily replace and couple the floss may be provided.

As described above, the optimal embodiments of the present disclosure have been disclosed through the detailed description and the drawings. However, those skilled in the art or those of ordinary skill in the art will appreciate that various modifications and changes are possible without departing from the spirit and technical scope of the present disclosure as set forth in the claims below.

Therefore, the technical protection scope of the present disclosure is not limited to the detailed description described in the specification, but should be determined by the appended claims.

What is claimed is:

1. A replaceable floss device comprising:
a main body extending in a longitudinal direction and including a handle portion and a head unit, the head unit being configured to form a receiving area spaced apart from the handle portion in the longitudinal direction and including a receiving protrusion and a receiving recess; and
a replaceable floss unit replaceably coupled to the main body, and including a base portion including a coupling protrusion and a coupling recess, an arm portion extending in a direction different from the direction in which the base portion extends, and a floss coupled to the arm portion,
wherein when the replaceable floss unit is coupled to the main body, the base portion is positioned in the receiving area so that the coupling protrusion and the receiving recess are in contact with each other and the coupling recess and the receiving protrusion are in contact with each other,
wherein the replaceable floss unit is coupled to the head unit along a coupling direction in which the floss and the base portion are spaced apart from each other, and the coupling direction and the longitudinal direction are different from each other, and
wherein the receiving area includes a first receiving end open toward the handle portion and a second receiving end formed opposite the first receiving end, and overlaps at least a portion of the handle portion along the longitudinal direction.

2. The device of claim 1, further comprising:
an open area fluidically connected to the receiving area and surrounded by at least a portion of the handle portion and at least a portion of the head unit,
wherein the handle portion further includes a curved neck portion forming at least a portion of the open area, connected to at least a portion of the head unit, and having an outer surface that is curved on a side facing the open area.

3. The device of claim 2, wherein the head unit includes a connecting head unit, a coupling head unit, and a spacer head unit formed integrally with each other to form a U-shape,
wherein the connecting head unit is connected to one end of the coupling head unit and the spacer head unit is connected to the other end of the coupling head unit, and
wherein the curved neck portion is connected to the connecting head unit and is physically spaced apart from the spacer head unit.

4. The device of claim 3, wherein the base portion includes a front surface facing the floss and a rear surface formed opposite the front surface, and
wherein when the replaceable floss unit is coupled to the main body, the front surface of the base portion is in contact with the coupling head unit and the rear surface of the base portion is open so that the coupling head unit presses at least a portion of the base portion.

5. The device of claim 3, wherein the arm portion includes a first arm portion extending from one end of the base portion and a second arm portion extending from the other end of the base portion,
wherein the floss is coupled between the first arm portion and the second arm portion, and
wherein when the replaceable floss unit is coupled to the main body, the first arm portion is provided in the open area and the second arm portion is provided around the second receiving end.

6. The device of claim 5, wherein the open area formed by the curved neck portion is not formed on the second receiving end.

7. The device of claim 5, wherein the floss has a first tension when the replaceable floss unit is not coupled to the main body and has a second tension greater than the first tension when the replaceable floss unit is coupled to the main body, and
wherein a straight-line distance between distal ends of the first arm portion and the second arm portion is a first distance when the replaceable floss unit is not coupled to the main body and is a second distance greater than the first distance when the replaceable floss unit is coupled to the main body.

8. The device of claim 7, wherein a curvature of the base portion is a first curvature when the replaceable floss unit is not coupled to the main body and is a second curvature smaller than the first curvature when the replaceable floss unit is coupled to the main body.

9. The device of claim 5, wherein the replaceable floss unit further includes a coupling portion being in contact with at least a portion of the head unit when the replaceable floss unit and the head unit are coupled to each other, and having a cavity structure,
wherein a direction in which the coupling portion and the floss are spaced apart from each other is different from the longitudinal direction,
wherein at least a portion of the coupling portion is formed by the base portion, and another portion of the coupling portion is formed by the arm portion, and
wherein the coupling portion includes a first coupling portion adjacent to the first arm portion and a second coupling portion adjacent to the second arm portion.

10. The device of claim 9, wherein the coupling portion forms a first included angle when the replaceable floss unit is not coupled to the main body, and the coupling portion forms a second included angle when the replaceable floss unit is coupled to the main body, and
wherein the second included angle is greater than the first included angle.

11. The device of claim 10, wherein the first included angle is 90 degrees or less.

12. The device of claim 9, wherein the coupling portion includes an inner surface and includes a fastening portion which is an end of the inner surface adjacent to an inner portion of the arm portion,
wherein when the replaceable floss unit is not coupled to the main body, the fastening portion of the first coupling portion and the fastening portion of the second coupling portion are spaced apart from each other by a first separation distance, and when the replaceable floss unit is coupled to the main body, the fastening portion of the first coupling portion and the fastening portion of the second coupling portion are spaced apart from each other by a second separation distance, and
wherein the first separation distance is smaller than the second separation distance and smaller than a head length of the coupling head unit.

13. The device of claim 1, wherein each of the receiving protrusion and the coupling protrusion has a curved cross-sectional shape, and
wherein each of the receiving recess and the coupling recess has a cross-sectional shape corresponding to the receiving protrusion and the coupling protrusion.

14. The device of claim 1, wherein the base portion has a thickness greater than that of the arm portion.
